(19) United States
(12) Patent Application Publication
(10) Pub. No.: US 2004/0265773 A1
(43) Pub. Date: Dec. 30, 2004

(54) Dental air-polishing device

(76) Inventors: Dominique Mariaulle, Le Haillan (FR); Thierry Casabonne, Bordeaux (FR)

Correspondence Address: YOUNG & THOMPSON, 745 SOUTH 23RD STREET, 2ND FLOOR, ARLINGTON, VA, 22202, US

(21) Appl. No.: 10/491,781

(22) PCT Filed: Oct. 11, 2002
(86) PCT No.: PCT/FR02/03464

(30) Foreign Application Priority Data
Oct. 11, 2001 (FR) 01.13110

(51) Int. Cl. A61C 3/02

(52) U.S. Cl. 433/88

(57) ABSTRACT

A dental air-polishing tool includes a body (2) and a nozzle (3), the latter being designed to spray under pressure on the teeth to be polished, an abrasive powder surrounded with a liquid jet. The tool is characterized in that the nozzle (3) includes three deformable elements, namely a first tubular element (10) forming an axial channel, a second tubular element (9) externally concentric thereto, a third tubular element, arranged between the first two (9, 10), and which is provided with longitudinal channels (13) providing a fluid flow. The three elements (9, 10, 11) are capable of being curved and straightened, at least one of them being designed to maintain the other two in the curved or straightened position which has been imparted thereto.

The present invention relates to a dental handpiece and more particularly to an air-polishing device.

It is known that such devices are used for projecting onto a patient's teeth an abrasive powder, advantageously constituted for example by sodium bicarbonate. From the practical standpoint, the apparatus projects, on the one hand, the powder under pressure via a central channel and, on the other hand, water around the central jet via an annular channel.

In devices of this type of the prior state of the art, the injection nozzle forms a given angle with the longitudinal axis of the tool which, by definition, is determined during its manufacture in the factory. Now, it proves upon use that this predetermined angle is not forcibly in conformity with the specific morphology of the different patients and with the type of usual hold of the practitioner, with the result that the latter are sometimes inconvienced in the use of the instrument. Even in the hypothesis of this angle suiting the practitioner for a determined type of intervention, it may happen that it is totally inappropriate for another type of work and/or a different patient.

The present invention has for its object to overcome this drawback by proposing an air-polishing tool allowing its user to shape it in order to match the individual morphology of his patients and with his own

modes of hold, for each determined type of intervention, and this without this modification of shape having a practical influence on the flows delivered.

The present invention thus has for its object a dental air-polishing tool of the type comprising a body and a nozzle, the latter being intended to spray under pressure, onto teeth to be polished, an abrasive powder surrounded by a jet of liquid, characterized in that the nozzle comprises three deformable elements, namely:

a first tubular element forming an axial, longitudinal, internal channel,

a second tubular element externally concentric thereto,

a third tubular element, or spacer element, which is arranged between the first two, which is in abutment, substantially over the whole of its length, thereagainst and which is provided with longitudinal channels allowing a circulation of fluid from its posterior end up to its anterior end,

these three elements being capable of being curved and straightened, at least one of them being adapted to maintain the other two in the curved or straightened position which will have been imparted thereto.

The element adapted to ensure maintenance in position will preferably be the outer tube.

In an interesting form of embodiment of the invention, the three elements will form a removable sub-assembly, this allowing the practitioner to proceed with sterilization of this part of the instrument, easily.

A form of embodiment of the present invention will be described hereinafter, by way of non-limiting example, with reference to the accompanying drawings, in which:

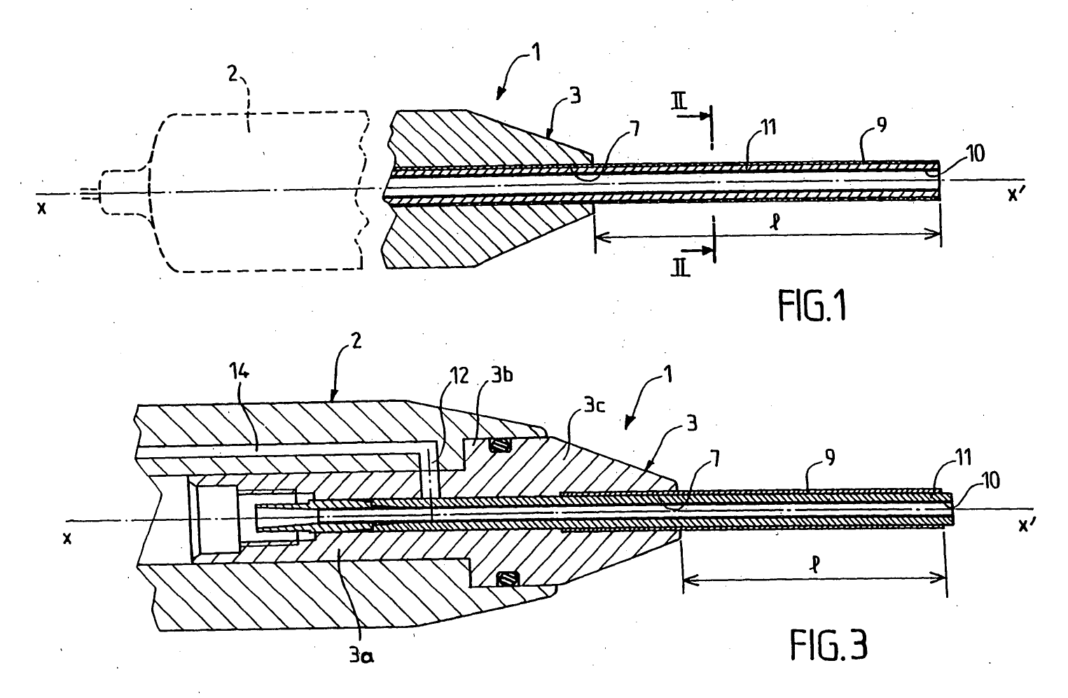

FIG. 1 is a view in axial, longitudinal section of a spray nozzle disposed in a hand piece of an air-polisher according to the invention.

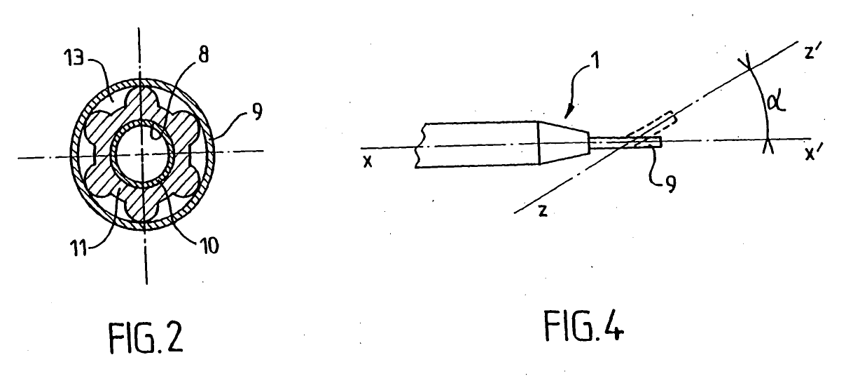

FIG. 2 is a view in cross-section on a larger scale of the spray nozzle shown in FIG. 1 along line II-II thereof.

FIG. 3 is a vie in axial, longitudinal section of a variant embodiment of the spray nozzle shown in FIG. 1.

FIG. 4 is a partial schematic view in elevation, on a smaller scale, of a spray nozzle according to the invention.

FIGS. 1 and 2 show an air-polishing instrument 1 according to the invention which is intended to be fitted in a hand piece 2, shown schematically in FIG. 1, and which allows the practitioner to grip the instrument. The anterior part of the latter terminates in a nozzle 3 which is pierced with an axial, longitudinal channel 7 in which is fixed a metallic tube 9, or outer tube, which extends outside the nozzle 3 over a certain distance 1.

The inner face of the outer tube 9 receives a spacer element 11 which is made of an easily deformable material which, in addition to its qualities in the domain of health, must, moreover, be able to withstand the temperatures necessitated by a treatment in an autoclave, such as for example FEP (fluorinated ethylene propylene) or PTFE (polytetrafluoroethylene), and of which the outer face is hollowed out with longitudinal grooves 13 which extend over the whole of its length and which constitute with the inner surface of the tube 9 longitudinal channels. The spacer element 11 has an axial channel 8 hollowed out therein which receives a central tube 10 which is in good contact therewith.

The outer tube 9 is preferably constituted by stainless steel which has undergone a thermic operation of annealing so as to impart thereto a good capacity to undergo a deformation and conserve it thereafter, after the stress to which it was subjected has ceased.

It is known that the deformation of tubes by curving is a delicate operation which requires instruments and proven techniques, otherwise an angular crushing of the tube is provoked.

According to the invention, it has been ascertained that the spacer element 11 arranged between the two outer (9) and central (10) tubes performs in fact two functions, namely a first technical function of maintaining these two concentric tubes at a constant and determined distance, which is favourable for a regular flow of the fluids delivered, and a second function which is that of transmitting from one tube to the other any deformation which is applied to one of them and in particular from the outer tube 9 towards the central tube 10, this making it possible to ensure a regular curvature of the tubes and to avoid the afore-mentioned phenomenon of angular crushing.

Although, in the majority of cases, the outer tube 9 will be constituted by a material of good deformability adapted to conserve the deformation which was applied thereto after the stress of deformation ceased, this role might equally well be allotted to the central tube 10, possibly to the two tubes 9 and 10 or even equally well to the spacer element 11.

When the user wishes, as shown in FIG. 4, to modify the angle α formed by the axis zz′ at the exit of the nozzle 3 with the longitudinal axis xx′ thereof, he exerts a bending torque on the outer tube 9 and, in the course of the resulting curvature, the spacer element 11 retransmits, at all the corresponding points of the axial tube 10, the stresses that it undergoes, with the result that the two tubes are deformed regularly without forming a folding.

As shown in FIG. 3, the nozzle 3 of the polisher may interestingly comprise means allowing it to be rendered easily removable, particularly at the end of sterilization.

Such a nozzle 3 is thus constituted in the example shown in the Figure by a tubular posterior part 3a which extends forwardly in a cylindrical part 3b of larger diameter and which terminates in a truncated anterior part 3c. This latter receives the outer tube 9 inside which are disposed the spacer element 11 and the central tube 10. The nozzle 3 is fitted in a cylindrical recess of complementary shape which is provided in the anterior part of the hand piece 2.

The supply of the central channel (not shown in the drawing) is, for example, ensured from the posterior part of the nozzle 3 and that of the annular channel is ensured via a radial hole 12 which opens out in the latter and which is in communication with a channel 14 provided in the body of the hand piece 2.

According to the invention, the spacer element 11 may, of course, be made of a material such as annealed stainless steel adapted to conserve, after the stress has ceased, the angle α which will have been imparted thereto by bending. In such a form of embodiment, the outer (9) and central (10) tubes may be made of a supple and elastic material such as for example FEP or PTFE.

1. Dental air-polishing tool of the type comprising a body (2) and a nozzle (3), the latter being intended to spray under pressure, onto teeth to be polished, an abrasive powder surrounded by a jet of liquid, characterized in that the nozzle (3) comprises three deformable elements, namely:
a first tubular element (10) forming an axial, longitudinal, internal channel,
a second tubular element (9) externally concentric thereto,
a third tubular element, or spacer element (11), which is arranged between the first two (9, 10), which is in abutment, substantially over the whole of its length, thereagainst and which is provided with longitudinal channels (13) allowing a circulation of fluid from its posterior end up to its anterior end,
these three elements (9, 10, 11) being capable of being curved and straightened, at least one of them being adapted to maintain the other two in the curved or straightened position which will have been imparted thereto.

2. Tool according to claim 1, characterized in that the element adapted to ensure maintenance in position is the outer tube (9).

3. Tool according to claim 1, characterized in that the three elements (9, 10, 11) form a removable sub-assembly.

4. Tool according to claim 1, characterized in that the spacer element (11) is constituted by FEP or PTFE.

5. Tool according to claim 2, characterized in that the three elements (9, 10, 11) form a removable sub-assembly.

6. Tool according to claim 2, characterized in that the spacer element (11) is constituted by FEP or PTFE.
